(19) United States
(12) Patent Application Publication
(10) Pub. No.: US 2006/0125444 A1
(43) Pub. Date: Jun. 15, 2006

(54) Adapter battery unit for backup powering video camera devices

(76) Inventors: Chiu Nang Wilson Lam, Kowloon (CN); Wai Chan, Kowloon (CN)

Correspondence Address: ALIX YALE & RISTAS LLP, 750 MAIN STREET, SUITE 1400, HARTFORD, CT, 06103, US

(21) Appl. No.: 11/009,238

(22) Filed: Dec. 10, 2004

(51) Int. Cl. H02J 7/00

(52) U.S. Cl. 320/107

(57) ABSTRACT

An adapter battery unit for backup powering of a video camera device comprises a battery unit electrically and selectively connectable to an electronic device and is electrically and selectively connectable with a backup battery device. The adapter battery unit can be connected to the backup battery pack during operation of the electronic device without interruption in the power flow to the electronic device. In operation, the adapter battery unit supplies power to the camera device during normal operation of the camera. However, as the main battery in the adapter battery unit becomes discharged, a backup battery may be attached to the adapter battery without interrupting flow of power to the electronic device. In addition, when the adapter battery is connected to an external a/c power source, the adapter battery becomes charged and also acts as a charger to charge up the backup battery.

### FIELD OF THE INVENTION

The present invention generally relates to battery backup devices. In particular, the invention relates to a battery unit for supplying power to an electronic device and which is capable of being coupled with a backup battery without the need to interrupt the supply of power to the device.

### BACKGROUND OF THE INVENTION

Electronic devices such as video cameras are typically powered by detachable battery packs. These battery packs are often minimally sized, and are generally rechargeable. The battery packs typically have a power capacity that allows for the extended operation of electronic devices. The electronic devices are thus highly portable since the battery packs have a relatively small size and relatively large capacity which allows a user to take the device almost anywhere. The portability of electronic devices, for example video cameras, has increased the reliance placed on them in capturing socially important images and sounds. This reliance has created a critical need that video camera not become disabled due to battery discharge while capturing socially noteworthy images and sounds.

Conventionally, video cameras have relied on large battery capacity combined with the camera operator's personal estimate of when important events would unfold before the camera. A miscalculation by the operator results in images and sounds being lost. Conventionally, when the camera operator determines that the battery is running low, the operation of the camera must be interrupted while the discharged battery source is replaced with a charged battery source. Typically, this operation requires tens of seconds or minutes to complete. During the period of time from when a battery has been discharged until a new battery source has been installed, the device cannot capture information.

There remains a need for an non-interruptible battery pack that will lessen or eliminate the problems of the conventional battery packs for electronic devices.

### SUMMARY OF THE INVENTION

Briefly, in one advantageous embodiment, an adapter battery unit for backup powering of a video camera device comprises a battery unit electrically and selectively connectable to an electronic device. The adapter battery pack is also electrically and selectively connectable with a backup battery device. The adapter battery unit can be connected to the backup battery pack during operation of the electronic device without interruption in the power flow to the electronic device. In operation, the adapter battery unit supplies power to the camera device during normal operation of the camera. However, as the main battery in the adapter battery unit becomes discharged, a backup battery may be attached to the adapter battery without interrupting flow of power to the electronic device.

An object of the invention is to provide an adapter battery unit which is used for powering video camera devices and which is capable of being coupled to a backup batter when the adapter battery unit is being discharged.

Another object of the present invention is to provide an adapter battery unit which can be quickly connected or disconnected from the camera and/or the backup battery.

A further object of the present invention is to provide an adapter battery unit that may be simultaneously discharged or recharged with the backup battery. In some embodiments the original battery of the camera device may be used as the backup battery unit.

### BRIEF DESCRIPTION OF THE DRAWINGS

Other objects and advantages of the invention will be evident to one of ordinary skill in the art from the following detailed description made with reference to the accompanying drawings in which:

FIG. 1 is a schematic drawing showing the electrical pathways relative to a camera, an adapter battery unit, and a backup battery unit consistent with the present invention.

FIGS. 2A-2C are perspective views of the positional relationship between a camera, an adapter battery unit, and a backup battery unit consistent with the present invention.

FIGS. 3A-3B are perspective views of the positional relationship between a camera, an adapter battery unit, and a backup battery unit consistent with the present invention.

FIGS. 4A-4B are perspective views of the positional relationship between a camera, an adapter battery unit with a guard cover, and a backup battery unit having a optional connecting surface consistent with the present invention.

### DETAILED DESCRIPTION OF THE PREFERRED EMBODIMENT

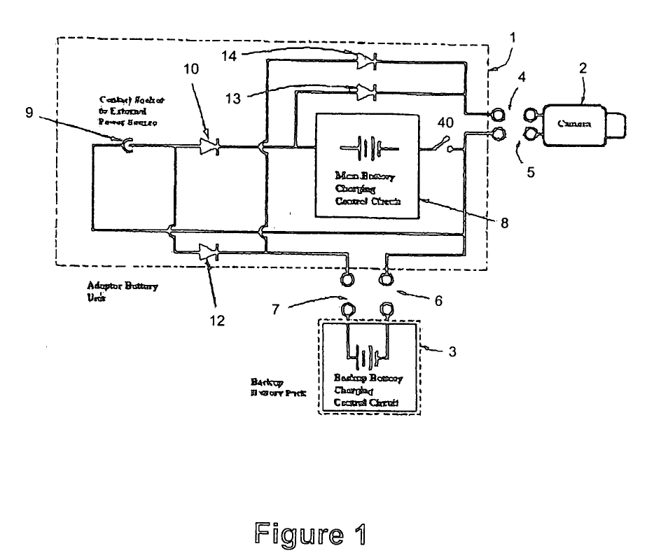

With reference to FIG. 1, the adapter battery unit 1 according to one embodiment of the present invention comprises an internal power source 8. The internal power source 8 includes a main battery cell and a charging control circuit. The adapter battery unit 1 includes diode elements 10, 12, 13 and 14. The diode elements 10, 12, 13 and 14 are positioned in the electrical pathway of the adapter battery unit 1 such that electrical current flow can flow in a single direction. For example, the diode elements 10, 12, 13 and 14 ensure that power does not flow back toward the power source 8 or a backup battery 3.

The adapter battery unit 1 includes, in one embodiment of the invention, a set of DC contact poles 4 for connecting the adapter battery unit 1 to a set of DC contact poles 5 located on a camera 2. The adapter battery unit 1 also includes a set of contact poles 6 for connecting the adapter battery unit 1 to a set of contact poles 7 on the backup battery 3.

In one embodiment of the invention, the adapter battery unit 1 has a DC contact socket 9 for connecting the adapter battery unit 1 to an external power supply (not shown). The external power supply when connected to the DC contact socket 9 can be used to recharge the battery in the internal power source 8. The external power, provided through the DC contact socket 9, may also be used to power the camera 2. If the backup battery 3 is electrically connected to the adapter battery unit during charging of the internal power source 8 by the external power source, the backup battery 3 will also be charged.

In one embodiment of the invention, the adapter battery unit 1 provides a user with great flexibility in where devices may be used, as well as providing the user cost savings. For example, the internal power source 8 may include a charging control circuit, as shown in FIG. 1. The charging circuit may receive power from the DC contact socket 9, thus allowing a user to plug the adapter battery unit 1 into, for example, a car cigarette light port. As an additional example, in one embodiment of the invention, the adapter battery unit 1 can be used to charge the backup battery 3 when separated from the camera 2. The adapter battery unit 1 can thus operate as an AC/DC power input charger. This can provide a user with the cost savings of not having to purchase a separate portable charger. In one embodiment of the invention, a switch 40 is included for selecting between the backup battery 3 and the adapter battery unit 1.

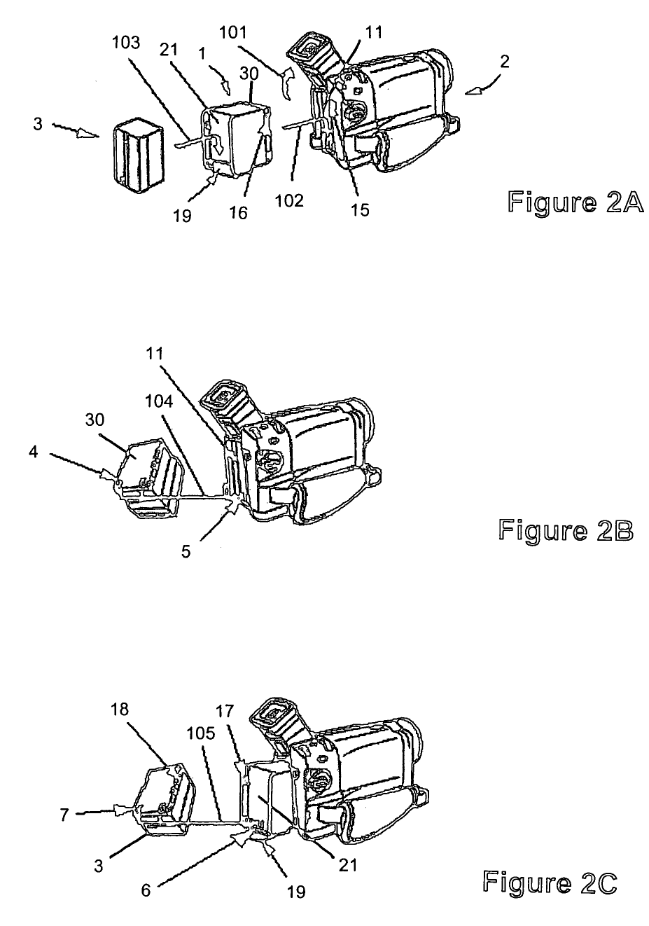

With reference to FIG. 2A-2C, in one embodiment of the invention, the adapter battery unit is configured to have at least two connective surfaces. A first connecting surface 30 is configured to selectively attach to, for example, a battery docking surface 11 of a camera 2. The first connecting surface 30 has, as shown in FIG. 2B, a set of DC contact poles 4. The battery docking surface 11 allows for connection to the adapter battery unit 1 by mechanical engagement of slots 16 with protrusions 15 at, for example, each sidewall of the battery docking surface 11. The battery docking surface 11 also allows for electrical connection to the adapter battery unit 1 via a set of DC contact poles 5.

In use, the adapter battery unit 1 may be attached to the battery docking surface 11 by moving the adapter battery unit along a docking pathway 102, as shown in FIG. 2A. As shown in FIG. 2B, the DC contact poles 4 and DC contact poles 5 are configured to come into electrical contact when the adapter battery unit 1 is connected with the battery docking surface 11.

The second connecting surface 21 of the adapter battery unit 1, in one embodiment of the invention, engages with the backup battery 3. The mechanical engagement of the backup battery to the second connecting surface 21 is facilitated by engagement of slots 18 with protrusions 17 at, for example, each side of the second connecting surface 21.

In use, the backup battery unit 3 may be attached to the connecting surface 21 by moving the backup battery unit along a connecting pathway 103, as shown in FIG. 2A. As shown in FIG. 2C, the set of DC contact poles 7 on the backup battery 3 and the DC contact poles 6 on the second connecting surface 21 are configured to come into electrical contact when the backup battery unit 3 is connected with the second connecting surface 21.

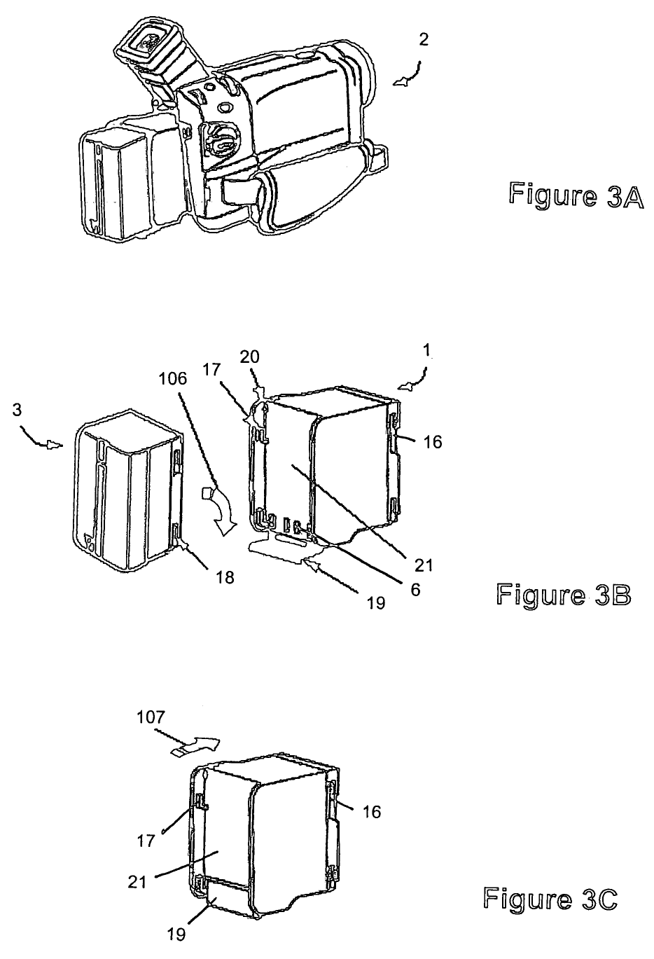

With reference to FIGS. 3B and 3C, in one embodiment of the invention, the adapter battery unit has protrusions 17 at each side of the second connecting surface 21. These protrusions 17 are configured to engage into recess slots 18 on the backup battery 3. The engagement of the backup battery to the adapter battery unit, as shown in FIG. 3B, includes a ratchet attachment pin 20. In use, the ratchet attachment pin 20 locks the backup battery 3 onto the adapter battery 1 as the backup battery unit engages with the second connecting surface 21. Disengagement of the backup battery 3 is accomplished by pushing the ratchet attachment pin 20 in the direction 107 to release the lock for disengaging the backup battery 3 from the adapter battery 1.

In one embodiment of the invention, as shown in FIGS. 3B and 3C, the set of DC contact poles 6 may be selectively covered by a spring loaded pole protection gate 19, wherein the spring loading biases the pole protection gate 19 to a position covering the poles 6. In operation, as the backup battery 3 is engaged with the second connecting surface 21, the spring loaded pole protection gate 19 is moved out of the way by the back up battery 3. Electrical contact of the set of DC contact poles 6 is then made possible. When the backup battery is removed, the pole protection gate 19 automatically covers the DC contact poles 6 due to the gate being spring loaded.

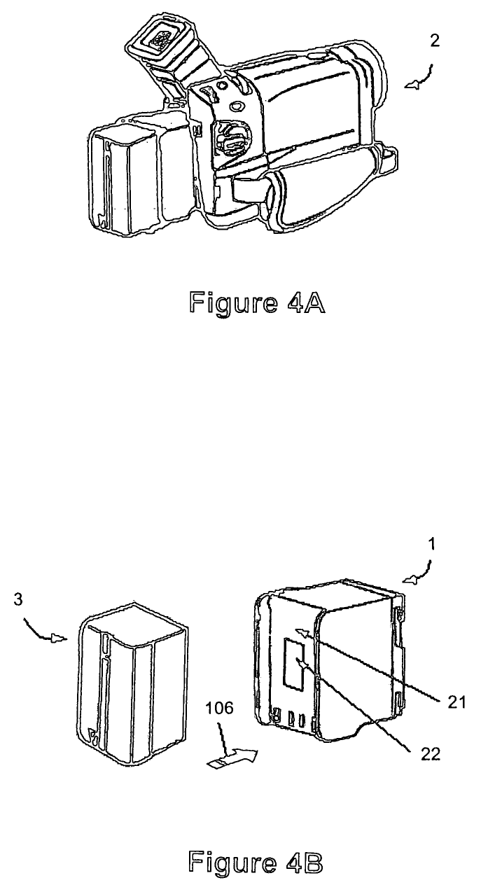

With reference to FIGS. 4A and 4B, in one embodiment of the invention, the backup battery may be fixed to the adapter battery unit 1 through the use of magnetic poles, hook & loop tape 22 (such as Velcro®), and/or adhesive elements. For example, when hook and loop tape 22 is used, one portion of the tape 22 is fixed to the adapter battery unit 1 and another portion of the tape 22 is fixed to the back-up battery 3. When the portions of the tape 22 are brought together a selective fixation of the backup battery 3 to the adapter battery 1 is made. This allows quick attachment of the backup battery 3 to the battery seat 21 by moving the back-up battery 3 along direction 106.

While preferred embodiments of the foregoing invention have been set forth for purposes of illustration, the foregoing description should not be deemed a limitation of the invention herein. Accordingly, various modifications, adaptations and alternatives may occur to one skilled in the art without departing from the spirit and scope of the present invention.

What is claimed is:

1. An adapter battery unit comprising:
a power source having a battery and a charging controller;
a first surface having an electrical contact configured to electrically connect the battery to an electronic device, and having a docking mechanism configured to mechanically connect with the electronic device;
a second surface having an electrical contact configured to electrically connect the electronic device with a backup battery unit; and
a socket for receiving an auxiliary power supply.

2. The adapter battery unit of claim 1, further comprising a diode element electrically positioned such that electrical current flows in a direction toward the electrical device.

3. The adapter battery unit of claim 2, wherein the diode element prevents electrical current from flowing in a direction toward the backup battery and the main battery.

4. The adapter battery unit of claim 1, further comprising a protective gate having a spring for biasing the protective gate to a covering position over the electrical contact on the second surface, said gate being movably fixed to the adapter battery unit such that the gate isolates the electrical contact on the second surface when the backup battery unit is not connected.

5. The adapter battery unit of claim 1, wherein the docking mechanism is a protrusion which engages with a slot on the electronic device.

6. The adapter battery unit of claim 1, wherein the docking mechanism is a plurality of flexible hooks which engages with a plurality of flexible loops on the electronic device.

7. The adapter battery unit of claim 1, wherein the docking mechanism includes a ratchet attachment element for locking the backup battery onto the second surface.

8. The adapter battery unit of claim 1, wherein the docking mechanism includes a slot on a side of the adapter battery unit, said slot being configured to selectively engage with a protrusion.

9. The adapter battery unit of claim 1, wherein the electronic device is a video camera.

10. A method of providing uninterrupted power to an electronic device comprising the steps of:
providing an adapter battery unit comprising a power source having a battery and a charging controller; a first surface having an electrical contact configured to electrically connect the battery to an electronic device, the first surface having a docking mechanism configured to mechanically connect with the electronic device; a second surface having an electrical contact configured to electrically connect the electronic device with a backup battery unit; and a socket for receiving an auxiliary power supply;
connecting the first surface of the adapter battery unit to the electronic device;
monitoring the main battery charge state; and
attaching the backup battery to the second surface of the adapter battery unit.

11. The method of providing uninterrupted power to an electronic device of claim 10, wherein the adapter battery unit further includes a protective gate having a spring, said gate being movably fixed to the adapter battery wherein the gate electrically isolates an electrical contact on the adapter battery unit and includes the steps of:
displacing the protective gate with the backup battery when the backup battery is attached to the second surface of the adapter battery unit.

12. The method of providing uninterrupted power to an electronic device of claim 10, wherein the first surface electrical contact is a first pair of DC poles, and the second surface electrical contact is a second pair of DC poles and includes the steps of:
contacting the first pair of DC poles to the second pair of DC poles when the first surface of the adapter battery unit is connected to the electronic device.

13. The method of providing uninterrupted power to an electronic device of claim 10, wherein the second surface includes a plurality of loops configured to connect with a plurality of hooks on the backup battery unit and includes the steps of:
contacting the plurality of loops with the plurality of hooks, and establishing electrical contact between the second surface electrical contact the adapter battery unit.

14. An adapter battery unit mounted to a video camera comprising:
an adapter unit comprising a power source having a battery and a charging controller, a first surface having an electrical contact electrically connecting the battery to an electrical contact on a video camera docking surface, said first surface and having a docking mechanism mechanically connecting the adapter battery unit to the video camera docking surface;
a second surface having an electrical contact electrically connecting the video camera with a backup battery unit; and
a socket configured to selectively receive auxiliary power supply.

15. The adapter battery unit mounted to the video camera of claim 14 wherein the docking mechanism is a protrusion which engages with a slot on a wall of the video camera docking surface.

16. The adapter battery unit mounted to the video camera of claim 14 further including an external power source contact for charging batteries and powering the video camera.

17. The adapter battery unit mounted to the video camera of claim 14 further including an electrical switch electrically positioned to allow selective electrical connection between either the battery and the electrical contact on a video camera docking surface, or with the video camera and the backup battery unit, which is further to allow selection of electrical flow.
